(19) United States
(12) Patent Application Publication
(10) Pub. No.: US 2005/0229452 A1
(43) Pub. Date: Oct. 20, 2005

(54) Evacuation and emergency visual annunciator (EEVA)

(76) Inventor: Daniel Doyle Shimasaki, Arlington, VA (US)

Correspondence Address: DANIEL DOYLE SHIMASAKI, 11821 ACRED STREET, ARLINGTON, IN, 38002, US

(21) Appl. No.: 10/751,704

(22) Filed: Apr. 16, 2004

(51) Int. Cl. G09F 13/04

(52) U.S. Cl. 40/573

(57) ABSTRACT

The Evacuation and Emergency Visual Annunciator or EEVA will be a low voltage evacuation and emergency visual annunciator panel box. The associated emergency panels (i.e. fire, tornado, earthquake, terrorism, etc., see drawing 1 and 2 behind Record of Invention) will measure 12″×12″, 8″×8″ or 6″×6″ as deemed necessary by the ordering entity. The panel box which will house both the strobes and panels will measure accordingly to fit ordered panels (i.e. if 12″×12″ panels were ordered the associated panel box would measure approximately 14″×14″ in order to accommodate the associated strobe and panel). Panel boxes will be approximately 2 to 2.5 inches thick. Strobes will be located in each separate section of a panel box. The activated strobe will light up intermittently at no more than ½ second intervals within the section of the annunciated panel box hence drawing visual attention to that specific section of the panel alerting the public to an emergency situation.

The Evacuation and Emergency Visual Annunciator will be low voltage as previously mentioned within my word document titled THE EVACUATION AND EMERGENCY VISUAL ANNUNCIATOR dated Jul. 20, 2002.

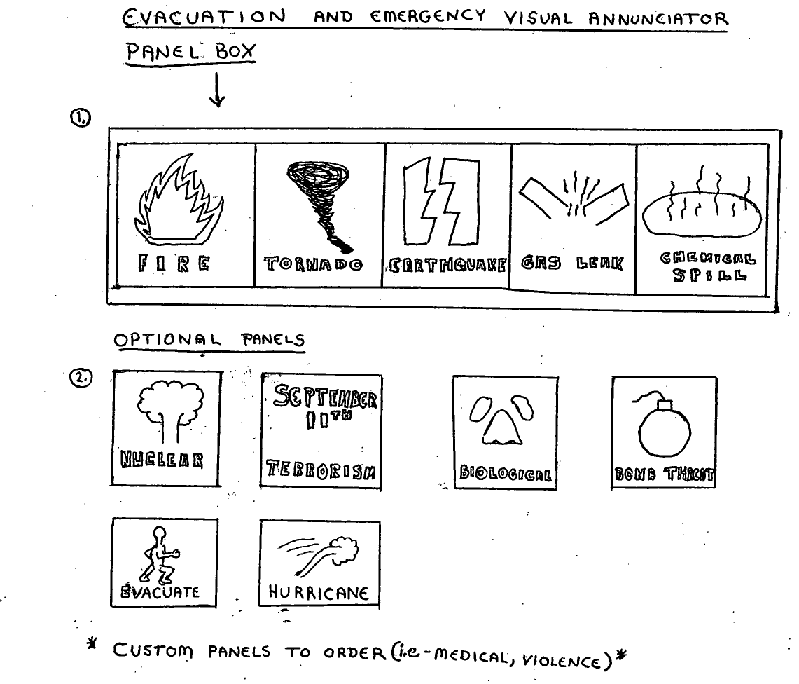

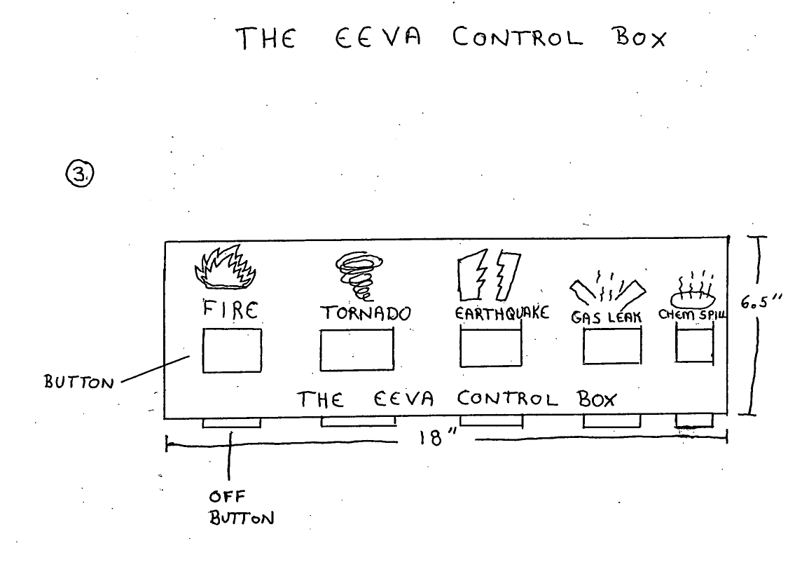

The thickness of the EEVA panel boxes (located above entry/exit points, commons areas, and preferred areas) will be approximately 2 to 2.5 inches in thickness (FIG. 1—attached drawing). The thickness of the EEVA control box (FIG. 3—attached drawing) will be approximately 1 to 2.5 inches in thickness. The thickness of the panels (FIGS. 1 and 2—attached drawing) will be approximately no more than 1/4 inch thick made of translucent plastic or glass material. The importance of this is so that the panels can visually indicate to an observer as to what type of emergency has transpired.

Previously stated within my word document titled THE EVACUATION AND EMERGENCY VISUAL ANNUNCIATOR dated Jul. 20, 2002 I wrote that the EEVA will be low voltage utilizing wire “runs” from the associated EEVA panel to the control box. The EEVA can also be “hardwired” in as are current audible and visual evacuation alarms.

The EEVA could even utilize radio frequency technology in which each EEVA panel box would be its own receiver of emergency broadcast information. This process would be similar to current weather radio technology in which certain tones originated by the emergency broadcasting system would activate each EEVA panel box with the associated emergency (i.e. terrorism) being displayed via strobes lighting associated panels associated audible alarms. In this case the off button (FIG. 3—attached drawing) would need to be pushed in order to turn all of the panel boxes off and reset into ready mode. This would be accomplished via a radio frequency unique tone generated from the local EEVA control box transmitted to each separate EEVA panel box.

The wire runned or hardwired EEVA panel boxes would be turned off via pushing in the off button (FIG. 3—attached drawing) resetting each panel box into ready mode.

1. The Evacuation and Emergency Visual Annunciator or EEVA. The EEVA will be an annunciator panel used in business and government building facilities in conjunction with their evacuation and emergency plans. It will provide visual aid to all individuals within the facility, as these annunciators will be installed above entry and exit points and personnel commons areas. They will also be installed in strategic locations as directed by the facility's senior management and/or their associated corporate senior management.
The EEVA will use interchangeable panels, custom made to the customer's order as not all threats are prioritized the same due to geographical and regional differences. An example of this would be hurricanes, in which, this natural event only applies to those facilities positioned along coastal areas.
The standard panels for industrial sites will measure either 12″×12″ or 8″×8″ as deemed necessary by that specific ordering entity:
Retailers, office facilities, government facilities, etc. will more than likely choose to custom order panels of different sizes (6″×6″, etc.) for aesthetic purposes and practicality.
As fire is the most common destructive and harmful threat to facility assets, the fire panel and evacuate panel will be standard on all annunciators. These panels will be tied into the existing facility fire alarm system. When the fire alarm system activates, the associated panel blocks (as shown in FIG. 1 on the Descriptive Material Page) will light up indicating to all persons within the facility, to include the hearing impaired (ADA) that the associated audible tone is related to fire evacuation. The rest of the annunciator will work in similar fashion. One other associated and distinctive audible tone different from the fire alarm tone will indicate to all individuals within the facility that an emergency has been declared. The associated emergency will be visually indicated to all within the facility as to what needs to transpire (i.e.—go to tornado gathering points, evacuate facility due to gas leak, etc.).
The declared emergency and the associated EEVA panel lighting will be accomplished through the manual pushing of associated buttons canned previously within the EEVA control box as shown on the attached Descriptive Material Page as FIG. 3. The facility emergency coordinator and/or his/her designee will accomplish the pushing of the associated buttons (i.e.—tornado, earthquake, gas leak, chemical spill, etc.). The associated declared emergency panel and/or panels will light up in conjunction with the distinctive audible tone indicating that an emergency has been declared.
Panels will not only be semi translucent to allow the inner bright light within the panel box to shine through but will also be of distinctive coloring (i.e.—fire-red, tornado-blue, earthquake-yellow, gas leak-green, chemical spill-orange, etc.).
The associated panel light will strobe intermittently at no more than ½ second intervals to be more attention getting. The strobing/lighting effect will have to be turned off manually after the associated emergency has been declared over by the appropriate responsible party.
The EEVA will be low voltage utilizing wire “runs” from the associated EEVA panel to the control box. All EEVA panels will be tied into the control box positioned in a secure area within the associated facility. The EEVA also will be able to be “hardwired” in, as are current audible and visual evacuation alarms.
The thickness of the EEVA panel boxes (located above entry/exit points, commons areas, and preferred areas) will be approximately 2 to 2.5 inches in thickness (FIG. 1—attached drawing). The thickness of the EEVA control box (FIG. 3—attached drawing) will be approximately 1 to 2.5 inches in thickness. The thickness of the panels (FIGS. 1 and 2 attached drawing) will be approximately no more than ¼ inch thick made of translucent plastic or glass material.
The EEVA will also be able to utilize radio frequency technology in which each EEVA panel box would be its own receiver of emergency broadcast information. This process would be similar to current weather radio technology in which certain tones originated by the emergency broadcasting system would activate each EEVA panel box with the associated emergency (i.e. terrorism) being displayed via strobes lighting associated panels and associated audible alarms. In this case the off button (FIG. 3—attached drawing) would need to be pushed in order to turn all of the panel boxes off and reset into ready mode. This would be accomplished via a radio frequency unique tone generated from the local EEVA control box transmitted to each separate EEVA panel box.
The wire runned or hardwired EEVA panel boxes would be turned off via pushing in the off button (FIG. 3—attached drawing) resetting each panel box into ready mode.
The EEVA will be an invaluable asset to all structural facilities that have, at any time, persons within. The lives that will be saved, the regulatory compliance adherence, upgraded asset protection and aid to those with disabilities due to the EEVA functions, will be invaluable and immeasurable in regards to lives' and costs' savings.
The time for the EEVA is now due not only to recent events (Sep. 11, 2001) but also due to the day to day threats (fire, tornado, etc.) common to all structural facilities.
